(19) United States
(12) Patent Application Publication
(10) Pub. No.: US 2025/0274586 A1
(43) Pub. Date: Aug. 28, 2025

(54) GENRE CLASSIFICATION FOR VIDEO COMPRESSION

(71) Applicant: MELLANOX TECHNOLOGIES, LTD., Yokneam (IL)

(72) Inventors: Dotan David Levi, Kiryat Motzkin (IL); Dror Porat, Haifa (IL); Limor Martin, Givatayim (IL); Yury Shvartzman, Raanana (IL); Ohad Markus, Haifa (IL); Eshed Ram, Nofit (IL); Eyal Frishman, Hod Hasharon (IL)

(21) Appl. No.: 18/587,491

(22) Filed: Feb. 26, 2024

(51) Int. Cl. H04N 19/142; G06T 7/13; G06V 10/44; H04N 19/139

(52) U.S. Cl. CPC H04N 19/142; G06T 7/13; G06V 10/44; H04N 19/139

(57) ABSTRACT

Systems and methods herein are for at least one execution unit that can perform an inference using a machine learning (ML) model and that is coupled to a video encoder, where the ML model can determine a genre associated with received frames of a media stream based in part on using ML model features associated with different genres, where the video encoder can encode the media stream based in part on the determined genre.

### TECHNICAL FIELD

At least one embodiment pertains to video compression for frames of a media stream using an encoding that is based in part on a genre classification of one or more of the frames.

### BACKGROUND

Video compression can be used to provide reduced media streams while preserving detail, to an extent, of content of an underlying video. Deep video compression techniques may be used with video compression. However, such deep video compression of a video may still require many parameters for tuning, to determine and limit operation of the video compression, for instance. A substantial part of the parameters provide different effects on different video. For example, one parameter may be used to improve a quality or to reduce a bitrate in part of a video being compressed. However, such one solution plan may have negative effects for different kind of content as the one solution may not suit the content under compression. While an approach may be to leave selection of parameters to users of the video compression, such as by an input to a configuration for the video compression, most users may not be informed about a relation between a video sequence of the content and available parameters to provide any benefit to the video compression. For example, a user may not be able to determine if there will be a positive or a negative impact using a parameter with a specific content. As a result, the parameters available may not be enabled by default and may not be used in a consumer environment for video compression.

### BRIEF DESCRIPTION OF DRAWINGS

FIG. 1 is an illustration of a system for video compression using genre classification, in at least one embodiment;

FIG. 2 is an illustration of aspects of a machine learning (ML) model having sub-ML models to perform different inferences to provide genre classification for received frames, in at least one embodiment;

FIG. 3 is an illustration of aspects of a machine learning (ML) model having supervised training, unsupervised training, or semi-supervised training to provide genre classification for received frames, in at least one embodiment;

FIG. 4 illustrates computer and processor aspects of a system for video compression using genre classification, in at least one embodiment;

FIG. 5 illustrates a process flow for a system for video compression using genre classification, in at least one embodiment;

FIG. 6 illustrates yet another process flow for a system for video compression using genre classification, in at least one embodiment; and

FIG. 7 illustrates a further process flow for a system for video compression using genre classification, in at least one embodiment.

### DETAILED DESCRIPTION

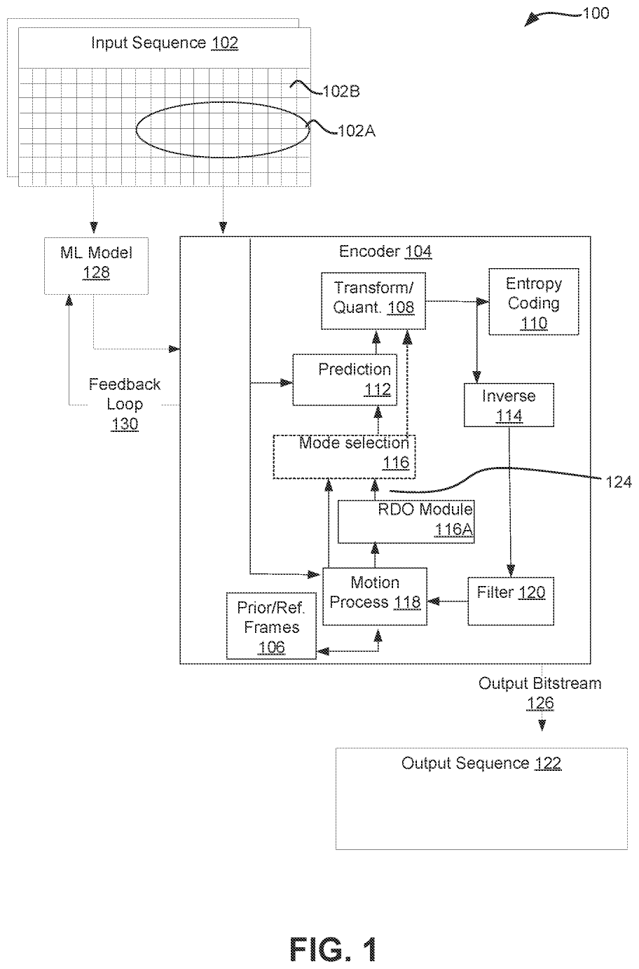

FIG. 1 is an illustration of a system 100 for video compression using genre classification, in at least one embodiment. The system 100 includes at least one circuit to perform as an encoder 104 that may be a video encoder and includes at least one other circuit to perform inference using a machine learning (ML) model 128. For example, an inference by the ML model is to determine a genre in received frames of an input sequence 102, for a media stream. As used herein, a genre may be represented by at least one feature that may discriminate different genre in an objective manner. Therefore, to determine a genre herein may be to determine, by an ML model, at least one feature for a genre. Further, as used herein, a genre may not be subjective as its underlying feature is objectively quantified and classified by an ML model. The genre, as used herein with respect to an ML model, may be different than readily apparent to a human observer. However, in at least one embodiment, a feature may be tied to a genre and may be apparent to a human observer by the use of labeling, such as, in a supervised training of the ML model using labeled features tied to labeled genres.

Determination of a genre, by an ML model, is to enable the encoder 104 to perform efficient encoding that is suitable to the genre of an input sequence 102 in a media stream. As used herein, an input sequence 102 may include multiple frames subject to encoding after an underlying genre can be determined by a trained ML model 128. In one example, the system 100 supports training of the ML model 128 to classify, into at least one genre, each input sequence 102 (or sets of scenes within the input sequences) of a media stream. Even though illustrated in the singular, an input sequence is continuously received and encoded. Therefore, the input sequence may include determination of different genres therein and may be subject to different encoding by different encoding parameters.

The system 100 is also enabled, using the encoder 104, to choose default video compression parameters, reflecting the different encoding parameters, that are specific to the determined genre. The system 100 is also enabled, using the encoder 104, to perform video compression or encoding that is devoid of some or all of the default video compression parameters. The video compression parameters are also referred to herein as encoding parameters. In at least one embodiment, the encoding parameters herein may include content-adaptive parameters and a configuration for total compression gain from the content-adaptive parameters. The total compression gain may be high relative to compression that is devoid of such content-adaptive parameters.

In at least one embodiment, the genre under classification herein may include, without limitations, natural content, camera help content, sports content, screen content, gaming content, cartoons, automotive content, medical imaging content, machine generated content, hand-held camera content, remote desktop applications, stationary camera content, and user-generated content (UGC). Different genres may benefit from different information retained during video compression. For example, medical imaging content may benefit from retaining information in areas pertaining to a study of a medical issue, whereas automotive content may benefit from retaining information in areas having automobiles in its surrounding areas. Therefore, any surrounding or remaining areas having content that is of less or no interest may be subject to higher compression than the retained information areas.

Genre classification by the ML model 128 enables the encoder 104 to perform encoding using encoding parameters that ensure retained information can maintain bits, for instance, in certain areas 102A of interest, and that ensure compression to save bits in the surrounding or remaining areas 102B of the content represented in the input sequence 102. In at least one embodiment, instead of established genres, it is possible to explore different genres using specific features of video coding standards. For example, screen content for remote desktop applications may use specific encoding parameters that may be provided from an industry standards body. The use of such encoding parameters for training an ML model to associate against specific genres may be established using supervised learning, in at least one embodiment. In this manner, it is possible to objectify genres according to encoding parameters, other than noise features, different distributions of motion vectors, different intensity levels of pixels, or different edge features.

The training enabled for the ML model 128 may be performed naively by supervised learning, where tagging or labeling is provided in each sequence (or a set of scenes). Alternatively, the training enabled for the ML model 128 may be performed by unsupervised learning, where different video content (or areas thereof) may be initially subject to encoding sets using different encoding parameters, which may be classified by a trained ML model 128. In yet another alternative, the training enabled for the ML model 128 may be performed by semi-supervised learning, where parts of the sequence may include a label and may be subject to classification along with other parts of the sequence, by the ML model 128. In each approach, a best fit may be used by an ML model 128 to inform the training by establishing classes of different genres, for example. Then, input video content of an input sequence 102, during testing or in a live environment, may be classified against the established classes.

In one example, the ML model 128 may be trained using different features associated with the different genre. The different features may be associated with one or more of noise features, distributions of motion vectors, intensity levels of pixels, or edge features, in one instance. For example, one or more of the different noise features, the different distributions of motion vectors, the different intensity levels of pixels, or the different edges may be different for the different genres. For example, at least the intensity levels of pixels may be higher for certain part of the natural content versus certain medical imaging content. In an analogous manner, edges may be more defined for cartoon or screen content than for other types of genre.

In addition, the different noise features may include white noise in images, whereas the different distributions of motion vectors enables support for content of varying motion, such as a low median that may be the case in low relative motion within the content, against a high median that may be the case in high relative motion, than the low media, in the content. Further, the benefits of relying on intensity levels of pixels may be important to discriminate medical imaging content but not as important to discriminate natural content. Similarly, noise features and distributions of motion vectors may be different for gaming content and automotive content due in part to constant movement associated with such content. Therefore, such different features may discriminate different genres and may be used to define the different genre.

Once trained, the ML model 128 may use such features in an input sequence, which is to be encoded, to determine a genre in the input sequence by determining a best fit against a trained classes established by the ML model 128. The encoder 104 may perform the encoding for the media stream that includes the input sequence 102, based in part on encoding parameters that are suitable to the determined genre. The encoder 104 provides an encoded media stream, also referred to herein as an output bitstream. As detailed herein, however, the encoder 104 may be caused to provide different encoded media stream in a dynamic manner. For example, an initial input sequence may be encoded according to a first determined genre. Then, based at least in part on a scene cut event that introduces at least one further input sequence or a change in the input sequence (or set of scenes), a further classification by the trained ML model 128 may be performed.

For example, the initial genre may be determined by the ML model and informed to the encoder. However, the ML model may not perform inferences on further input sequence until the encoder informs the ML model of a scene cut event in the input sequence relative to a further input sequence. The dynamic encoding may be supported by a feedback loop from the encoder 104 to the ML model 128. In at least one embodiment, one or more processors or execution units of a processor provide one or more different circuits that may be used to perform the encoder 104 distinctly from the ML model 128. Based in part on the feedback in the feedback loop, a further inferred genre may be provided to the encoder to use different encoding parameters for the further input sequence. The ML model 128 may be trained to classify entire input sequences or a set of scenes into different genre so that the encoder can perform the encoding to include different encoding parameters for the different input sequences. However, the ML model 128 may be trained to classify each input sequence as it is received and based in part on a scene cut event to enable dynamic encoding by the encoder 104.

Further, the classification by the ML model 128 may be used to enable a mode selection or parameter selection for an encoder 104 to perform encoding that is specific to the genre in an input sequence. For example, the mode selection or parameter selection may be associated with available ones of the encoding parameters to provide different but specific encoding for each genre or underlying feature. Further, while the ML model 128 may perform an initial classification or inference for a media stream, a scene cut event may be indicated back to the ML model 128 from the encoder 104 using the feedback loop 130. The scene cut event may be associated with input sequences of the media stream, such as being within two different input sequences. The scene cut event may be used as a point at which the ML model 128 is involved to determine a new genre of following scenes or a following input sequence.

In at least one embodiment, the use of the ML model 128 to classify input sequences of video content based in part on a scene cut event allows for dynamic encoding as genre changes occur in a media stream. An encoded media stream may, therefore, have different video sequences that correspond to the input sequences 102, with different encoding parameters representing different genres as a result of different encoding required by changes in genre as a video content progresses and as testing and encoding occur in a dynamic manner. The different encoding parameters representing different genres may occur over time and are not required to be carried in the output bitstream 126 at a single point in time. However, it is also possible to provide the different encoding parameters representing different genres in the output bitstream 126 within a predetermined period if the inputs sequences have different genres determined by the ML model 128 or if the ML model 128 receives feedback and makes changes based in part on updates to the ML model 128 or different mode selection, for instance.

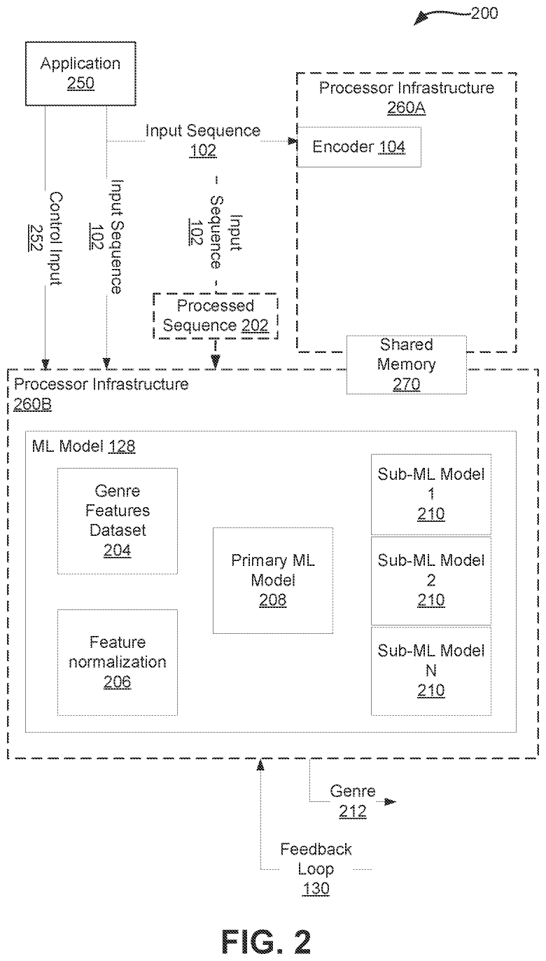

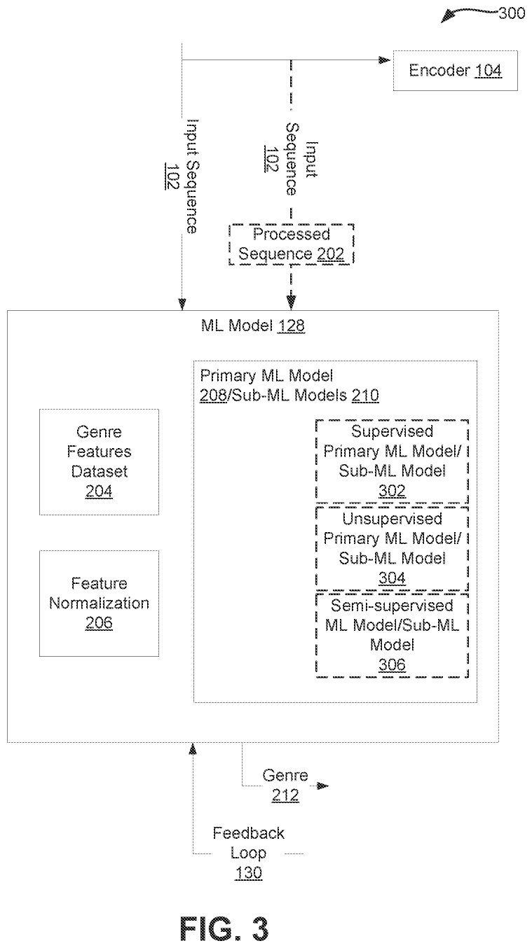

The training of the ML model may incorporate supervised training, unsupervised training, or semi-supervised training. In one or more of such training, at least a part, all, or none of any available scenes within an input sequence of different genres may be labeled. In at least the unsupervised and semi-supervised learning, a media stream of different genres may be part of an encoding set and the ML model classifies different features associated with different genres to cause an encoder to perform different encoding for the different genres in the input sequences. Therefore, the ML model enables a mode selection or parameter selection for an encoder that is suitable to a genre provided form the ML model. In addition, while described in the singular, the ML model may include sub-ML models, as described with one or more of FIGS. 2 and 3, to perform different inferences for the input sequence. The inferences may cause the encoder to provide different encoding parameters in an output bitstream 126.

In at least one embodiment, as genre changes occur for an input sequence 102, it is also possible to provide the different inferences dynamically, which enable the different encoding parameters to also occur dynamically, over time for a video content associated with the output bitstream 126. Separately, in response to the at least one encoding parameter indicated to the ML model 128 from feedback provided by the encoder 104, it is possible to cause the encoder 104 to provide different encoding parameters in an output bitstream 126. This may be to reflect adjustments or updates, by or within the ML model 128. The adjustments or updates may be to associate at least one feature of a genre and an encoding parameter, based in part on the feedback. For example, an initial genre or associated feature may be indicated from the ML model 128 to the encoder 104. However, the selection of encoding parameters itself is provided by the encoder 104.

As the ML model 128 may not have the encoding information initially, the adjustments or updates after an initial genre or feature indicated to the ML model 128 may use sub-ML models to subsequently relate an encoding parameter with a feature for a genre. This process enables the sub-ML model to perform the adjustments or updates. Further, as the sub-models are of limited features or training, relative to a primary ML model, as described with respect to FIGS. 2 and 3, the use of the sub-ML models enable size reduction to the ML model or speeding up of inferences by the ML model based on feedback dynamically received from the video encoder to the ML model.

In at least one embodiment, the encoder 104, such as a video encoder, can receive at least one input sequence 102 associated with a media stream and can provide at least an output sequence 122 that is a compressed or changed version of the input sequence 102. Further, the output bitstream 126 is an encoded media stream that includes different encoding parameters representing different genres and that corresponds to the input sequence 102. For example, the different encoding parameters that are based on the different genres determined by the ML model 128, in at least one embodiment. In a further example, different genres may be represented in the different encoding parameters by at least one value or parameter change of one encoding parameter of a set of encoding parameters that represent the different encoding parameters. Therefore, different genres need not require all the different encoding parameter in the set to be different or have different values. As some video content may have a single genre all throughout, it is possible to make an initial determination of a genre that is used throughout the video content with the feedback only used to ensure that the encoding parameters are unchanged for the video content.

Further, it is also possible to cause updates to the encoding parameters if the feedback from the encoder to the ML model 128 indicates that a different feature is more prominent for the video content, even if the entire genre is unchanged. As such, the features may be separately trained to different sub-ML models and the feedback may be used to cause one of the sub-ML models to provide an inference for a different feature reflective of an aspect of a genre to be used as basis for encoding subsequent input sequences 102. For example, as dynamic encoding is provided herein, with genre or feature changes that occur in a media stream, the output bitstream may be changed over time. Therefore, as used herein, a genre for the ML model 128 may pertain to one or more features that individually or altogether represent a genre of video content. As such, although the term genre is used herein, the genre and its classification, when described with reference to the ML model 128, may be different than subjectively understood to a human observer. The genre and its classification, when described with reference to the ML model 128, may be specific to specific features trained to the ML model 128 and may be different than subjectively understood to a human observer.

While illustrated in the singular, the encoding performed by the encoder 104 is to an input sequence or set of scenes that are all indicated as having the same genre, by the ML model 128. The encoding performed is to provide an output bitstream that is an encoded media stream having different video sequences that are associated with different encoding parameters of the different genres, as determined by the ML model 128. In at least one embodiment, the encoder 104 may be based in part on one of an H.264 standard, an MPEG2 standard, an AVC standard, an HEVC standard, a VP9 standard, an AV1 standard, or a VVC standard. However, the encoder 104 may be any encoder standard that allows weighting input, such as by mode selection using a quantization parameter (QP).

FIG. 1 illustrates that, in aspects of video encoding, a mode selection may be made to perform inter or intra mode coding. Such a mode selection may be performed using a mode selection module 116. The mode selection may enable selection of parameters that may be associated with available ones of the encoding parameters. The result of such mode selection is to provide specific encoding based in part on the classification from the ML model 128. The mode selection can also allow determination of how many bits the encoder 104 is willing to sacrifice in order to conceal and/or eliminate a distortion that may be relevant to certain parts of media content belonging to certain genres.

In at least one embodiment, there is trade-offs between bits used and distortion for the encoding performed. The trade-offs may be associated with distortion that may be different between different encoders. For example, the trade-offs may be between different user presets, different target bit rate (such as, possibly affecting a bit budget), and between different frames in a group of frames (GOP), representing an input sequence 102, to be encoded. However, with the genre classification herein, the trade-offs may be suited to different genre so that useful information for a genre is preserved during encoding. In another example, a trade-off may include a possibility that some distortion occurs, within general areas 102B of an input sequence 102, and ensures that no distorting (or relatively lesser distortion) applies to certain areas 102A of interest, during the encoding as pertinent to a genre determined for the input sequence.

Video compression may require intensive computation workloads with present state-of-the-art compression ratios providing 1/200 to 1/1000 compression but requiring more compute resources to perform such compression. However, with artificial intelligent and machine learning (AI/ML) workloads using large quantities of images and video, autonomous cars generating a large amount of video in each car, applications like smart cities requiring more video data, content created for entertainment requiring higher video resolution and more bit depth, and present-day remote-working video conferencing technologies, it is appreciated that video compression must be performed is more efficient manner. The efficient manner may be a reliance on genre determination by an ML model followed by an encoder to performing encoding using the determined genre. Further, it is appreciated that human eye limitations, along with the use of color space conversion and separation of luma (brightness) and chroma provide aggressive quantized or decimated features that may be limiting in providing quality video compression. Whereas, the use of an ML model enables objective genre determination for an encoder.

As used herein, a system 100 of an ML model 128 that is trained to classify genre in a video sequence, enables certain parameters or modes in an encoder 104 to encode an input sequence and to provide an encoded media stream that is also referred to as an output bitstream 126 herein. The encoding, supported by the ML model for genre classification, allows economy of bits. In one example, the ML model for genre classification enables the encoder to select areas in frames of input sequences to preserve quality therein by encoding these areas in specific encoding parameters to reduce an effect of the compression on the input sequences. This allows more bits, in encoding of areas 102A of a video sequence, to achieve a desired quality where needed by a genre, and fewer bits to save on compute resources on other areas 102B of the input sequences 102 where an associated genre does not require encoding of every detailed aspect therein.

As part of the encoding parameters, a Fourier or other related transform may be performed on blocks within every frame to convert data therein to a frequency domain and to allow quantization or discarding of information based on select frequencies. In doing so, transform coefficients at lower frequencies may be less aggressively quantized than those of higher frequency. Separately, motion estimation may be used to capture and encode movements across video frames. While all such approaches or options attempt to improve video compression, they may all serve a similar goal to allow an encoder to compress video into smaller bitstreams by eliminating noise, artifacts, allowing at least more intensive motion estimation and exploiting temporal and spatial redundancy. However, as used herein, for certain genres, additional benefits may be realized by retaining bits only to certain parts of a video sequence relevant to a genre. For example, the aggressiveness of transform and quantization, provided by a transformation and quantization (T and Q) module 108, may be different for different genres.

In view of all such benefits, encoders may differ based in part on selections of proper tool(s) to enable aspects thereof to provide economy of bits. For example, the selections of proper tools is in reference to selection of encoding parameters to enable selection of areas (such as provided by macroblocks (MBs)) within frames of each input sequence 102 that are subject to more or less compression than other areas. This and other such approaches that may be defined within the encoder as different modes that may require more or less bits to ensure a desired quality. An RDO module 116A may be associated witha mode selection module 116 of an encoder 104 to address requirements by the use of RDO metrics, such as Sum of Squared Errors (SSE) or Sum of Transformed Differences (SATD) to determine a cost associated with each selection made and to enable a selection based on the cost.

Further RDO metrics allow further mode selection that benefit from evaluation using further quality measures, including VMAF, SSIM, MS-SSIM, or PSNR. The addressing of temporal effect may remain for an encoder 104, as it may be done on only a frame level using such further RDO metrics. Distortion may be determined as a difference from the original image. In at least one embodiment, the system 100 for video compression using genre classification herein includes the ML model 128 to enable improved selection of at least those quality measures that may be a basis for the mode selection provided by an RDO output 124 of the RDO module 116A. The improved selection of at least the quality measures may be used by the encoder 104 to perform the video compression for video sequences 102 and, in particular, to provide the video compression that is suitable to a genre. For example, the encoder 104 (also referred to herein as a video encoder) can receive transform coefficients or parameters, such as QPs. The RDO module 116A operates to optimize, for each point or block of a frame, an efficient representation that may include segmentation, prediction modes, motion vectors (MVs), or the QPs.

In at least one embodiment, use of the RDO output 124 is to make a selection of a mode, as provided by the RDO module 116A. The RDO also contributes to the encoding parameters available to be selected based in part on the genre classification for input sequences 102. In at least one embodiment, an interface may be provided between the encoder 104 and the ML model 128 to allow input to be received in the ML model 128, from the encoder 104, that reflects feedback from a feedback loop 130. Further, the interface can enable outputs to the encoder 104, from the ML model 128, which may be able to cause selection of certain video compression parameters for compression of input sequences 102. The video compression parameters reflect quality measures of the RDO output 124, for instance.

In at least one embodiment, an RDO may be limited to a single point for each block in each frame of an input sequence 102 and may be represented by a linear equation of R+λ*D, where 2 (lambda) is a multiplier and where an (R, D) pair may be used with the multiplier to minimize a combined R+D value. R may be associated with a bit rate and D may be associated with distortion as it pertains to quality of the media. The RDO allows ranking, for instance, of candidate solutions using the linear equation to select one of the candidate solutions. Therefore, the lambda value may be associated with a range from 1 to a minimized cost for the set of (R, D). R may be measured in bits and D may be a quality unit, such that the equation provides a measure of units of distortion for every bit of a bit rate used in a video compression process.

To achieve a predetermined bit rate of R, a certain value of lambda may be used. The ML model 128 herein enables selection of encoding parameters that may include R, D, and lambda values to allow the RDO to use different quality measures to different genre. This is performed to ensure that an effect of the video compression performed in the video encoder is based at least in part on the genre associated with the underlying video content. In at least one embodiment, therefore, the system 100 herein uses the ML model 128 to optimize an encoder 104 so that different quality measures, representing different video compression parameters, may be used with different genre.

In at least one embodiment, as illustrated in FIG. 1, the encoder 104 is associated with at least one execution unit of a processor that performs inferences using the ML model 128. The encoder 104 may include an output to provide feedback, through a feedback loop 130, from the encoder 104 to the ML model 128. In an example, the output can indicate a scene cut event or at least one of different encoding parameters used by or available in the video encoder to the at least one execution unit. For example, the at least one of the different encoding parameters are an encoding parameter of a prior input sequence.

The ML model 128 is able to use the at least one of the different encoding parameters of the prior video sequence to update the ML model 128 or to perform further training, retraining, or testing (including inferences) of the ML model 128. Therefore, the ML model 128 can enable a different encoding to occur dynamically for the input sequence, such as for a subsequent input sequence that has a different genre, relative to a prior or initial input sequence, as determined by the ML model 128 and that is based at least in part on the scene cut event. The encoder 104 may also include an input to receive different inferences for the received frames of the subsequent input sequence, in response to the at least one of the different encoding parameters provided in the feedback loop. For example, the ML model 128 may include sub-ML models to provide the different inferences for subsequent input sequences, as described further with respect to FIGS. 2 and 3.

In at least one embodiment, FIG. 1 provides an encoder 104 that is subject to H.264 encoding. The encoder 104 includes modules in hardware or software, such as a prediction module 112, the T and Q module 108, and an entropy coding module 110. There may be further modules, such as an inverse module 114, a filter module 120, a motion process module 118 (to support motion estimation and related aspects), and a prior or reference frames module 106. The video compression using genre classification herein does not have effect on a decoding process for a bitstream provided from the encoder 104 that includes the output frame 122. For example, the decoding process may be according to the H.264 decoding or other decoding relevant to the encoding format used to provide the output bitstream 126 from the encoder 104 and, particularly, as to the entropy coding module 110.

A bitstream of frames, representing the input sequence 102 to be compressed may include different MBs. In at least one embodiment, different sizes of MBs may be supported in the encoder 104, including but not limited to 8×8, 8×16, 16×8, 4×4, and 16×16. The MBs likely correspond to displayed pixel data obtained at the location of the blocks. The prediction module 112 can generate a prediction MB that can be used to generate residual data reflective of data subject to quantization, as part of the video compression. There may be multiple prediction options associated with a prediction module 112, including intra prediction that is associated with previously encoded data that is from a current sequence, such as the input sequence 102. Another option associated with a prediction module 112 includes inter prediction that uses encoded data from other previously encoded frames, namely reference frames, such as from the prior or reference frames module 106. These reference frames can appear before or after the current frame, in the display order and may be associated with motion compensation, such as motion process module 118 that uses previously coded frames, such as provided from the prior or reference frames module 106.

Yet another option associated with a prediction module 112 includes the use of different prediction block sizes that is available to both, the intra prediction and inter prediction options. The use of different prediction block sizes of the MBs can change an accuracy associated with the predictions. A further option associated with a prediction module 112 includes the use of multiple frames during prediction, which is available in the inter prediction option to provide better accuracy in the predictions. A still further option is to skip MB data or residual data so that the encoder 104 itself performs an inference of the MB data based in part on the prediction MB. One or more of such options represent encoding parameters that may be applied to compress an input sequence 102 of a media stream based in part on a genre selection by an ML model 128.

In at least one embodiment, intra prediction may be based at least in part on spatial data within at least one frame of an input sequence 102. MBs generated as part of the intra prediction may be distinct from the MBs of the frame of the input sequence 102. Residual data may be residual MBs generated by a subtraction of the prediction MB, from a current MB. The residual MB can be subject to transformation, quantization, and entropy coding in the provided modules 108, 110 depending on a mode selected by a mode selection module 116 and that may be associated with the RDO module 116A to perform the RDO, for instance. Further, in the encoder 104, quantized data may be re-scaled and inverse transformed in the inverse module 114. An output of the inverse module 114 may be filtered and combined with the prediction MB in the prediction module 112. Motion estimation from the motion process module 118 may be included. The result may be a reconstructed MB or decoded frames that is provided to the prior or reference frames module 106 for further predictions. In at least one embodiment, the use of one or more of inter prediction or intra prediction represent additional encoding parameters that may be applied to compress an input sequence 102 of a media stream based in part on a genre selection by an ML model 128.

FIG. 2 is an illustration of aspects 200 of a machine learning (ML) model having sub-ML models 1-N 210 to perform different inferences to provide genre classification for received frames, in at least one embodiment. In one example, the ML model 128 may include sub-ML models 1-N 210 to perform different inferences for the input sequence. The different inferences may be in response to the at least one of the different encoding parameters indicated by feedback to the ML model 128 through a feedback loop 130 from the encoder 104. This enables size reduction to the ML model 128 or speeding up inferences by the ML model 128, based on the feedback. Further, as the feedback is dynamically received from the video encoder 104 to the ML model 128, it is possible to update the ML model 128 or to perform further training or testing of the ML model 128.

FIG. 2 also illustrates that ML model 128 may be performed on different processor infrastructure 260B than the encoder 260A. Further, the ML model 128 may be controlled by an application 250 for which or on behalf of which the encoding is performed. The application 250 may provide control input to indicate that the ML model 128 is to perform the inference for input sequence 202. Separately, the video encoder 104 may be controlled by its respective processing infrastructure 260A to perform the encoding of the media stream based in part on capabilities associated with the processing infrastructure. For example, the capabilities may pertain to encoding standards enabled for the encoder 104, including H.264 standard, an MPEG2 standard, an AVC standard, an HEVC standard, a VP9 standard, an AV1 standard, or a VVC standard. Further, the application 250 and the processing infrastructure 260A, 260B may share memory 270, which may be part of the system 100, to enable the inference and to enable the encoding of the media stream.

In at least one embodiment, it is possible to use feedback of a scene cut event and at least one of the different encoding parameters together. While a genre 212 may be initially determined and indicated by the ML model 128 to the encoder 104 for use by the encoder 104, feedback of one or more of a scene cut event or at least one of the different encoding parameters may be provided to the ML model 128 to enable determination of further genres for at least one subsequent input sequence 102. In one example, a genre 212 is indicated as one or more values or other parameters that may be used in the encoder to select certain ones of the encoding parameters. However, the certain ones of the encoding parameters may not be known to the ML model 128. Therefore, with the feedback in the feedback loop 130, it is possible to inform the ML model 128 as to the encoding parameters used with the genre indicated or generally available in the video encoder. For example, feedback in the feedback loop 130 may indicate a scene cut event to the at least one execution unit and, subsequently, where an encoded media stream output from the video encoder is enabled to include different encoding parameters that are provided dynamically for the encoded media stream based at least in part on the scene cut event.

Thereafter, it is possible to update the ML model 128 to improve accuracy by training (including retraining) of the ML model 128 that associate together different encoding parameters used initially, with the genre indicated initially to the encoder 104. Further, this process enables an encoded media stream that is the output bitstream 126 to include the different encoding parameters of the different genres, as determined by the ML model 128 and that may be provided dynamically for the input media stream having the input sequences 102 illustrated. Further, as the process is performed in an on-going or dynamic manner, the encoded media stream that is the output bitstream 126 may be changed based at least in part on the scene cut event and may include different encoding parameters as the genre changes in the content of the input sequences 102.

The ML model 128 may include a genre features dataset 204 to retain features of the different genres that may be used for a primary ML model 208. In at least one embodiment, the primary ML model 208 performs a determination of an initial genre for an input sequence 102. Thereafter, a further determination may be performed dynamically, using the primary ML model 208 or using one or more of the sub-ML models 1-N 210, for subsequent ones of the input sequences. In at least one embodiment, therefore, the ML model 128 is defaulted to a primary ML model 208 comprised therein. Further, like the ML model 128 having the genre features dataset 204, the sub-ML models 1-N 210 may be associated with its own dataset that may be a portion of the genre features dataset 204. However, the primary ML model 208 may use or access all the features of the genre features dataset 204. Further, while a dataset may retain features, it may only do so to enable training, retraining, or updating of any one of the primary ML model 208 and the sub-ML models 1-N 210. In one example, the different encoding parameters provided via feedback to the ML model 128 may be provided to the genre features dataset 204 to be used in the retraining or updating of the ML model 128.

The ML model 128 include a feature normalization module 206 that preprocesses the features to provide normalized features or to enable classification of marginal features into new or established classes. Therefore, the genre features dataset 204 and the feature normalization module 206 may be used for both training and testing of the ML model 128. Further, the primary ML model 208, the sub-ML models 1-N 210, the genre features dataset 204, and the feature normalization module 206 may be performed by distinct circuits that may be memory, cache, buffers, processors, or execution units within the processors. Therefore, the retraining or updating for the ML model 128 may apply to primary ML model 208 or any of the sub-ML models 1-N 210.

In at least one embodiment, instead of the input sequence 102, a processed sequence 202 that may be a downsampled or filtered sequence of the input sequence 102, may be provided for the encoder 104 and to the ML model 128 to allow for application of video compression using genre classification, as described all throughout herein. A processed sequence 202 may be such that a color format conversion is provided to the input sequence 102, in one non-limiting example. In at least one embodiment, the processed sequence 202 may be such that certain aspects that correspond to features for use by the ML model 128 may be enhanced or suppressed to assist the testing of the ML model 128. Therefore, the ML model 128 may receive the processed sequence 202, whereas the encoder 104 receives the input sequence 102. In this manner, it is possible to reduce the workload on the ML model 128 for classifying the input sequence 102 as the classification may be performed on a downsampled version in the processed sequence 202, while the encoding is performed using the input sequence 102, as provided.

FIG. 3 is an illustration of aspects 300 of a machine learning (ML) model having supervised training, unsupervised training, or semi-supervised training to provide genre classification for received frames. Initially, supervised learning allows the ML model 128 to receive a set of labeled training data and is trained to recognize patterns in that data. Supervised learning may be provided for one or more of the features in the genre features dataset 204 by labeling associated with such features. Any of a primary ML model or a sub-ML model using such labeled features and having labeled classes may be regarded as a supervised ML model 302. Then, further labeled features from a feedback loop may be used for training, retraining, or updates for the supervised ML model 302. Separately, unsupervised learning may be provided for one or more of the features in the genre features dataset 204 by using the features as they exist and by causing the ML model 128 to determine patterns in the features without labels or instructions. Unsupervised learning allows determination of genres in unsupervised classes using existing features, relative to the supervised learning of a supervised ML model 302. As the features are implied as having associations to different genre, the unsupervised classes are presumed to provide different genre classification for encoding parameters to be used with an input sequence 102. For example, input sequences having features that classify under a certain one of the unsupervised classes of a trained ML model will cause encoding parameters of that unsupervised class to be used to perform encoding of the input sequences. There may be no labeling provided for such unsupervised classes. Any of a primary ML model or a sub-ML model using such unlabeled features and having unlabeled and unsupervised classes may be regarded as an unsupervised ML model 304. Then, encoding parameters received in a feedback loop and to be associated with the one or more of the features in the unsupervised classes allows for further training, retraining, or updates for the unsupervised ML model 304.

Further, semi-supervised learning may be provided for one or more of the features in the genre features dataset 204 by using the features in a combination of supervised and unsupervised learning. As such, a relatively smaller number of features, than used in supervised learning, may be labeled in the manner of the supervised learning. A relatively large number of features may be used even though unlabeled, in the manner of the unsupervised learning. The intent is to allow broader classification than provided by supervised learning and to provide classes even while being devoid of a large number of labeled features. Semi-supervised learning allows determination of genres in such combined classes using existing features to provide a semi-supervised ML model 306. As the features are a combination of labeled and implied features, having associations to certain genre, the combined classes provide different genre classification for encoding parameters to be used with an input sequence 102. For example, input sequences having features that classify under a certain one of the combined classes of a trained ML model will cause encoding parameters of that combined class to be used to perform encoding of the input sequences. There may be labeling provided for such combined classes based in part on the labeled features, for instance. Any of a primary ML model or a sub-ML model using such combined features, having both labeled and unlabeled features, and providing combined classes may be regarded as a semi-supervised ML model 306. Then, encoding parameters received in a feedback loop and to be associated with the one or more of the features in the unsupervised classes allows for further training, retraining, or updates for the semi-supervised ML model 306, as a labeled or unlabeled feature.

In at least one embodiment, in each of FIGS. 2 and 3, the genre features dataset 204 includes features such as, noise features for different genres, distributions of motion vectors for the different genres, different intensity levels of pixels for the different genres, and different edge features for the different genres. Further, a processed sequence 202 may be enabled using a downsampled or filtered sequence of the input sequence 102 that highlights one or more of such features. This process may be useful in training or testing the ML model 128. Further, each of the sub-ML models 1-N 210 in FIG. 2 may be trained to each of the features. Therefore, each of the sub-ML models 1-N 210 may have its own sub-genre features dataset 204 that is associated with only one of the features. As such, if a feature is determined, from a feedback, as being prominent in the encoding of an input sequence 102, the sub-ML model corresponding to that feature may be used with subsequent input sequences. Therefore, the system 100 supports inference, using the ML model, that is performed on processed versions or sequences 202 of one or more of the received frames. Further, the system 100 may also support inference, using the ML model, that is performed using one or more sub-regions 102A of one or more of the received frames.

In at least one embodiment, it is also possible to use the processed sequence 202 for features of one or more of the supervised, unsupervised, or semi-supervised ML model or sub-ML models 302-306. As certain features may be better classified than other features, it may be beneficial to a type of learning that is suitable to the clarity in the classification process. As such, while the encoder 104 receives the input sequence 102, the ML model 128 may receive different types of the processed sequence 202 depending on the sub-models 302-306 used, in one instance. As such, the sub-ML models in FIGS. 2 and 3, representing an ML model 128, can perform different inferences for the received frames in the input sequence 102, in response to at least one of the different encoding parameters provided as feedback to the ML model 128 or that is.

Still further, the sub-ML models in FIGS. 2 and 3, representing an ML model 128, are of different associated memory or processing capacities. As one or more of the sub-models may be trained using downsampled features and other sub-models may be trained using whole features, there may be distinct genre features datasets that are of different sizes and retained in different memory capabilities. Further, the primary ML model 208 and at least some of the sub-ML models 1-N 210 having whole features may require more processing capacity than those sub-ML models using downsampled features. The at least one execution unit can perform the ML model 128 using the primary ML model 208 or one of the sub-ML models 1-N 210, in response to at least one of the different encoding parameters indicated via feedback to the ML model 128. Further, the at least one execution unit can perform the ML model 128 based in part on a threshold capacity of at least one of the different associated memory or processing capacities. In one example, once trained, the primary ML model 208 or the sub-ML models 1-N 210 may be stored in memory and may be loaded to at least one execution unit to perform an inference based in part on the different encoding parameters to be provided in the output bitstream 126.

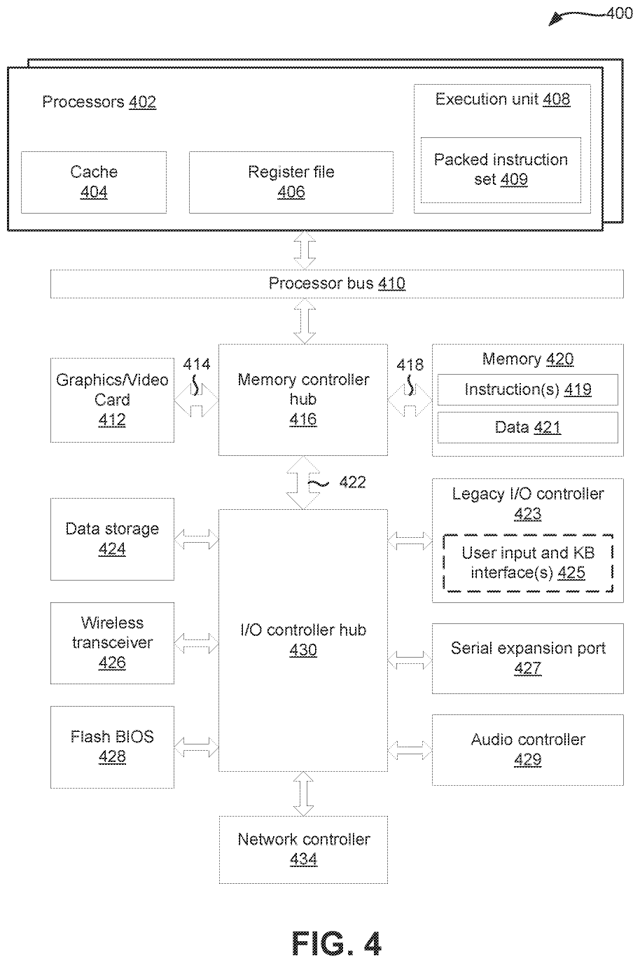

FIG. 4 illustrates computer and processor aspects 400 of a system for video compression using genre classification, in at least one embodiment. For example, each of the illustrated processors 402 may include one or more processing or execution units 408 that can perform any or all of the aspects of the system 100 for video compression using an encoder and using genre classification from an ML model. The system 100 may include an interface that may be between the encoder and the ML model to allow the feedback loop and the genre to be communicated between these two aspects of the system.

The processing or execution units 408 may include multiple circuits to support the aspects described herein for one or more of the encoder 104, the ML model 128, and the interface between these two aspects. In at least one embodiment, the processors 402 may include CPUs, GPUs, DPUs that may be associated with a multi-tenant environment to perform one or more of the encoder 104, the ML model 128, and the interface between these two aspects described herein. Further, the GPUs may be distinctly in distinct graphics/video cards 412, relative to a DPU (represented by a network controller 434) and a CPU represented by the processors 402 illustrated in FIG. 4. Therefore, even though described in the singular, the graphics/video card 412 may include multiple cards and may include multiple GPUs on each card.

The computer and processor aspects 400 may be performed by one or more processors 402 that include a system-on-a-chip (SOC) or some combination thereof formed with a processor that may include execution units to execute an instruction, according to at least one embodiment. In at least one embodiment, the computer and processor aspects 400 may include, without limitation, a component, such as a processor 402 to employ execution units 408 including logic to perform algorithms for process data, in accordance with present disclosure, such as in embodiment described herein. In at least one embodiment, the computer and processor aspects 400 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, the computer and processor aspects 400 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, the computer and processor aspects 400 may include, without limitation, a processor 402 that may include, without limitation, one or more execution units 408 to perform aspects according to techniques described with respect to at least one or more of FIGS. 1-3 and 5-7 herein. In at least one embodiment, the computer and processor aspects 400 is a single processor desktop or server system, but in another embodiment, the computer and processor aspects 400 may be a multiprocessor system.

In at least one embodiment, the processor 402 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, a processor 402 may be coupled to a processor bus 410 that may transmit data signals between processors 402 and other components in computer and processor aspects 400.

In at least one embodiment, a processor 402 may include, without limitation, a Level 1 (“L1”) internal cache memory (“cache”) 404. In at least one embodiment, a processor 402 may have a single internal cache or multiple levels of internal cache. In at least one embodiment, cache memory may reside external to a processor 402. Other embodiments may also include a combination of both internal and external caches depending on particular implementation and needs. In at least one embodiment, a register file 406 may store different types of data in various registers including, without limitation, integer registers, floating point registers, status registers, and an instruction pointer register.

In at least one embodiment, an execution unit 408, including, without limitation, logic to perform integer and floating point operations, also resides in a processor 402. In at least one embodiment, a processor 402 may also include a microcode (“ucode”) read only memory (“ROM”) that stores microcode for certain macro instructions. In at least one embodiment, an execution unit 408 may include logic to handle a packed instruction set 409.

In at least one embodiment, by including a packed instruction set 409 in an instruction set of a general-purpose processor, along with associated circuitry to execute instructions, operations used by many multimedia applications may be performed using packed data in a processor 402. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, an execution unit 408 may also be used in microcontrollers, embedded processors, graphics devices, DSPs, and other types of logic circuits. In at least one embodiment, the computer and processor aspects 400 may include, without limitation, a memory 420. In at least one embodiment, a memory 420 may be a Dynamic Random Access Memory (“DRAM”) device, a Static Random Access Memory (“SRAM”) device, a flash memory device, or another memory device. In at least one embodiment, a memory 420 may store instruction(s) 419 and/or data 421 represented by data signals that may be executed by a processor 402.

In at least one embodiment, a system logic chip may be coupled to a processor bus 410 and a memory 420. In at least one embodiment, a system logic chip may include, without limitation, a memory controller hub (“MCH”) 416, and processors 402 may communicate with MCH 416 via processor bus 410. In at least one embodiment, an MCH 416 may provide a high bandwidth memory path 418 to a memory 420 for instruction and data storage and for storage of graphics commands, data, and textures. In at least one embodiment, an MCH 416 may direct data signals between a processor 402, a memory 420, and other components in the computer and processor aspects 400 and to bridge data signals between a processor bus 410, a memory 420, and a system I/O interface 422. In at least one embodiment, a system logic chip may provide a graphics port for coupling to a graphics controller. In at least one embodiment, an MCH 416 may be coupled to a memory 420 through a high bandwidth memory path 418 and a graphics/video card 412 may be coupled to an MCH 416 through an Accelerated Graphics Port (“AGP”) interconnect 414. In at least one embodiment, the graphics/video card 412 may be coupled to one or more of the processors 402 via a PCIe interconnect standard. Similarly, a network controller 424 may also be coupled to one or more of the processors 402 via a PCIe interconnect standard.

In at least one embodiment, the computer and processor aspects 400 may use a system I/O interface 422 as a proprietary hub interface bus to couple an MCH 416 to an I/O controller hub (“ICH”) 430. In at least one embodiment, an ICH 430 may provide direct connections to some I/O devices via a local I/O bus. In at least one embodiment, a local I/O bus may include, without limitation, a high-speed I/O bus for connecting peripherals to a memory 420, a chipset, and processors 402. Examples may include, without limitation, an audio controller 429, a firmware hub (“flash BIOS”) 428, a wireless transceiver 426, a data storage 424, a legacy I/O controller 423 containing user input and keyboard interface(s) 425, a serial expansion port 427, such as a Universal Serial Bus (“USB”) port, and a network controller 434. In at least one embodiment, data storage 424 may comprise a hard disk drive, a floppy disk drive, a CD-ROM device, a flash memory device, or other mass storage device.

In at least one embodiment, FIG. 4 illustrates computer and processor aspects 400, which includes interconnected hardware devices or “chips”, whereas in other embodiments, FIG. 4 may illustrate an exemplary SoC. In at least one embodiment, devices illustrated in FIG. 4 may be interconnected with proprietary interconnects, standardized interconnects (e.g., PCIe) or some combination thereof. In at least one embodiment, one or more components of the computer and processor aspects 400 that are interconnected using compute express link (CXL) interconnects.

Therefore, the at least one execution unit 408 may be a circuit of at least one processor 402 to be associated with a video encoder. The association may be such that the at least one execution unit 408 of at least one processor 402 can perform the video encoder. The association may be such that the at least one execution unit 408 of at least one processor 402 can load and run or execute instructions to perform the video encoder. However, the association may be such that the at least one execution unit 408 of at least one processor 402 may be hardwired to perform the video encoder.

Further, the at least one execution unit 408 may be a circuit of at least one processor 402 to be associated with an ML model. The association may be such that the at least one execution unit 408 of at least one processor 402 can perform the ML model. The association may be such that the at least one execution unit 408 of at least one processor 402 can load and run or execute instructions to perform the ML model. However, the association may be such that the at least one execution unit 408 of at least one processor 402 may be hardwired to perform the ML model. Further, to support datasets, there may be other circuits, including the cache 404 that may be associated with the execution unit 408. To perform the ML model, however, the trained ML model may be loaded to the execution unit 408 and run or executed from therein. In addition, there may be a different execution unit that provides an interface between the execution units performing the ML model and the encoder.

The ML model can be used to determine a genre associated with received frames of a media stream based in part on imparted training to the ML model using features associated with different genres. The imparted training may be a supervised training, an unsupervised training, or a semi-supervised training. The at least one execution unit 408 of at least one processor 402 performing the encoder can also enable the encoder to encode the media stream based in part on the determined genre. An encoded media stream provided by the encoder may include different video sequences that are associated with different encoding parameters of the different genres, as determined by the ML model.

Further, the at least one execution unit 408 of the at least one processor 402 is so that the features used in the ML model performed therein include one or more of different noise features for the different genres, different distributions of motion vectors for the different genres, different intensity levels of pixels for the different genres, or different edge features for the different genres. For example, these features may be used for the imparted training and may be also used in the testing of the ML model to indicate to the encoder a genre of an input sequence.

The at least one execution unit 408 of the at least one processor 402 that performs the ML model may include an input to receive feedback from the at least one different execution unit 408 performing the video encoder. The feedback may be an indication of a scene cut event to the ML model. The scene cut event may be a basis for the ML model to perform an inference to determine a genre for a subsequent input sequence. The genre may be the same as a prior genre of a prior input sequence. The genre may include a different feature than the prior genre of the prior input sequence based in part on the feedback that may include an encoding parameter that was used by the encoder for the prior input sequence. Thereafter, based in part on the genre indicated to the encoder, an output bitstream having the encoded media stream may be enabled with the different encoding parameters of the different genres, as determined by the ML model and that is provided dynamically based at least in part on the scene cut event.

The at least one execution unit 408 of the at least one processor 402 that performs the ML model may include an input to receive feedback from the video encoder to indicate at least one of the different encoding parameters to the at least one execution unit. The ML model may include the sub-ML models to perform different inferences for the received frames in the input sequence, in response to the at least one of the different encoding parameters. For example, there may be a need for adjustments or updates, by or within the ML model, to associate at least one feature of a genre and an encoding parameter, based in part on the feedback. For example, an initial genre or associated feature may be indicated from the ML model to the encoder. However, the selection of encoding parameters itself is provided by the encoder. As the ML model may not have this information initially, the adjustments or updates after an initial genre or feature indicated to the ML model may use sub-ML models to subsequently relate an encoding parameter with a feature for a genre. This process can enable size reduction to the ML model or speeding up of inferences by the ML model based on feedback dynamically received from the video encoder to the ML model.

At least one execution unit 408 may be a circuit of at least one processor 402 to be associated with a video encoder to encode a media stream based in part on a genre associated with a media stream as determined using an ML model. The genre determined from received frames of the media stream may be based in part on imparted training to the ML model using features associated with different genres. An output bitstream of the encoder may be an encoded media stream that may include different video sequences that are associated with different encoding parameters of the different genres, as determined by the ML model. As a video content may be continuously subject to encoding and transmission to a decoder, it is appreciated that the output bitstream may have the different video sequences over a period of time at not at any instant, in at least one embodiment.

Further, the at least one execution unit 408 of the at least one processor 402 to be associated with a video encoder can include an output to provide feedback from the video encoder to the different one execution unit performing the ML model. The output can indicate a scene cut event or at least one of the different encoding parameters to the ML model. The different encoding parameters may be provided dynamically for the video stream based at least in part on the scene cut event and may be provided over time for the video content. The at least one execution unit 408 to be associated with a video encoder also includes an input to receive different inferences for the received frames. The different inferences may be in response to the at least one of the different encoding parameters provided via a feedback loop to the ML model. The ML model may use its included sub-ML models to provide the different inferences.

In at least one embodiment, at least one execution unit 408 of at least one processor 402 can be used to train an ML model using features associated with different genres for media streams. The ML model, once trained, is to enable a video encoder to encode a media stream based in part on a genre determined by the ML model for the media stream. Further, the ML model, once trained, is to enable the video encoder to provide an encoded media stream that includes different video sequences that are associated with different encoding parameters of the different genres, as determined by the ML model.

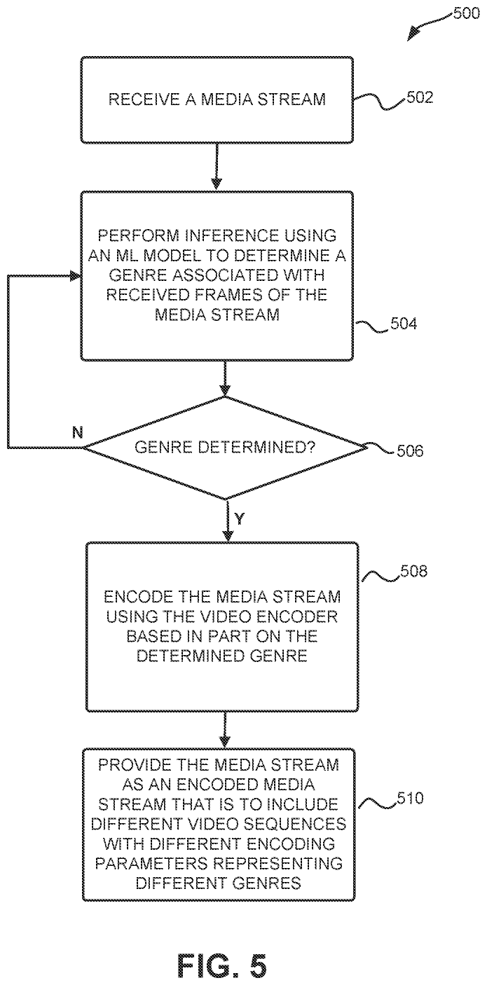

FIG. 5 illustrates a process flow or method 500 for a system for video compression using genre classification, in at least one embodiment. The method 500 includes receiving 502 a media stream that may include the input sequences described throughout herein. The method 500 includes performing 504 inference using an ML model to determine a genre associated with received frames of a media stream. This may be based in part on imparted training to the ML model using features associated with different genres. A verification 506 may be performed for a genre determined by the performing 504 step. The verification may be to ensure that classification is achieved at a determined threshold to allow an inference by the ML model. In at least one embodiment, the method 500 includes encoding 508 the media stream using the video encoder based in part on the determined genre. An encoded media stream may be provided 510 as part of the encoding, where the encoded media stream includes different video sequences that are associated with different encoding parameters of the different genres, as determined by the ML model.

The method 500 of FIG. 5 may include a further step or may include a sub-step in which the features include one or more of different noise features for the different genres, different distributions of motion vectors for the different genres, different intensity levels of pixels for the different genres, or different edge features for the different genres. The method 500 of FIG. 5 may include a further step or may include a sub-step in which the imparted training is a supervised training, an unsupervised training, or a semi-supervised training.

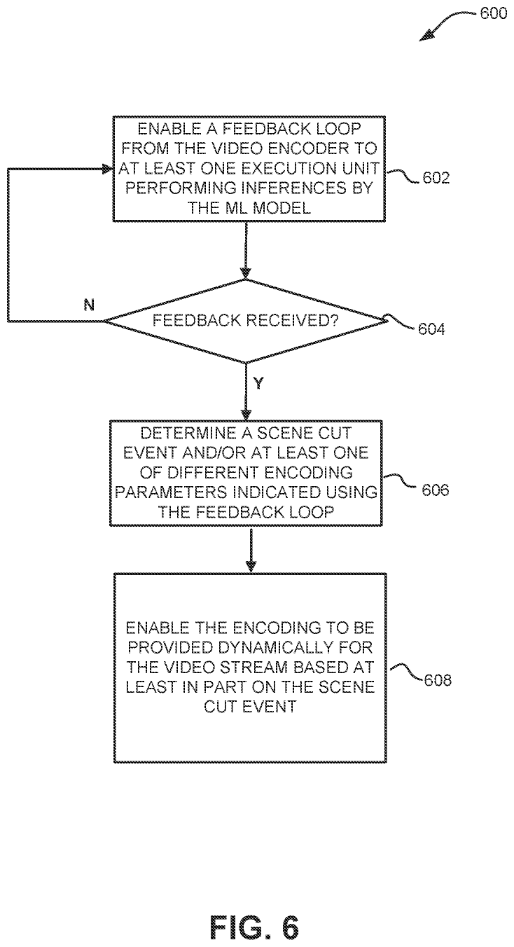

FIG. 6 illustrates yet another process flow or method 600 for a system for video compression using genre classification, in at least one embodiment. The method 600 of FIG. 6 may be used with the method 500 of FIG. 5. For example, the method 600 includes enabling 602 a feedback loop from the video encoder to at least one execution unit performing the inferences using ML model, which may be in step 504 of FIG. 5. The feedback loop may be enabled based in part on feedback sent from the video encoder, in one example. Therefore, although the feedback loop may physically exist, there may be no useful information provided there through until the feedback is provided to enable the performance of the ML model of step 504. In at least one embodiment, however, the enabling 602 step may be performed for subsequent input sequences of the media stream of step 502.

The method 600 includes determining or verifying 604 that feedback is received. For example, the ML model may be associated with an interface to expect certain types of information that may be predetermined types of information. When such types of information is received, it may be processed as feedback received under step 604. The method 600 include determining 606 a scene cut event from feedback in the feedback loop. The method 600 includes enabling 608 different encoding to be provided dynamically for the media stream based at least in part on the scene cut event. For example, initial encoding parameters may be provided for the encoded media stream, followed by adjustments, updates, or entirely different encoding parameters of different genres for subsequent input sequences in the media stream.

In at least one embodiment, the method 600 may include determining 606, separately or in addition to a scene cut event from feedback in the feedback loop, at least one of the different encoding parameters provided with the feedback. The method 600 includes the enabling 608 for the different encoding to be provided dynamically for the media stream based at least in part on the scene cut event and/or the at least one of the different encoding parameters. For example, initial encoding parameters may be provided for the encoded media stream, followed by adjustments, updates, or entirely different encoding parameters for subsequent input sequences in the media stream. However, in at least one embodiment, the enabling 608 step for the encoding to be provided dynamically may use sub-ML models of the ML model to perform different inferences for the received frames in response to the at least one of the different encoding parameters in the feedback.

The method 600 of FIG. 6 may include a further step or may include a sub-step in which the sub-ML models are of different associated memory or processing capacities. The method 600 may include a further step or may include a sub-step in which a threshold capacity of at least one of the different associated memory or processing capacities may be determined. Then, one of the sub-ML models may be used in the method 600 to perform the different inferences, in response to at least one of the different encoding parameters indicated to the ML model, and based in part on the threshold capacity.

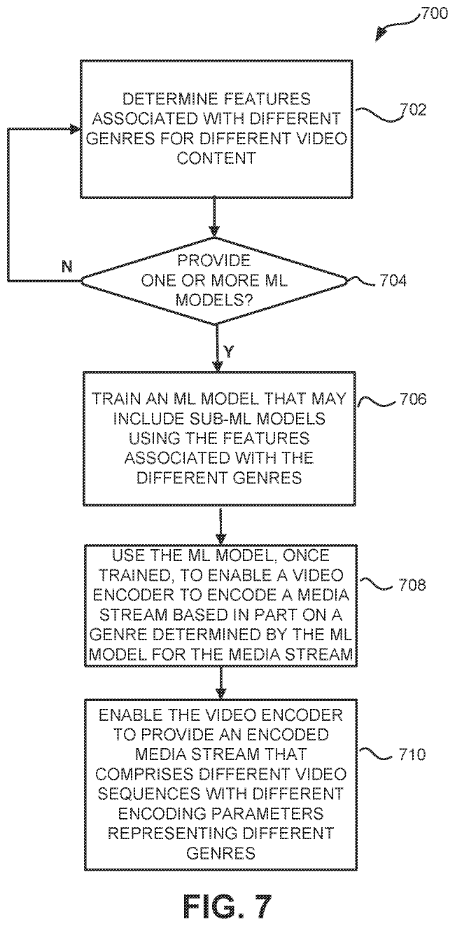

FIG. 7 illustrates a further process flow or method 700 for a system for video compression using genre classification, in at least one embodiment. The method 700 of FIG. 7 may be used with the method 500 of FIG. 5 or the method 600 of FIG. 6. For example, the method 700 may be associated with the training imparted to the ML model used in step 504 of the method 500 in FIG. 5. The method 700 in FIG. 7 includes determining 702 features that are associated with different genres for different video content. As described all throughout herein, the features may include one or more of different noise features for the different genres, different distributions of motion vectors for the different genres, different intensity levels of pixels for the different genres, or different edge features of the different genres.

The method 700 in FIG. 7 includes determining or verifying 704 to provide one or more ML models. For example, the determining or verifying 704 may apply to creating sub-ML models or to causing adjustments or updates to an existing primary ML model or to the sub-ML models. For example, when the feedback indicates encoding parameters for a genre that may not be associated with a best fit from a prior classification, there may be a new class associated with a new sub-ML model that may be provided to offer a further classification. The method 700 in FIG. 7 includes training 706 an ML model that may include the sub-ML models and a default primary ML model using features associated with the different genres. The method 700 in FIG. 7 includes using 708 the ML model, once trained, to enable a video encoder to encode a media stream based in part on a genre determined by the ML model. This may be in support of steps 504-508 of FIG. 5. The method 700 also includes enabling 710 the video encoder to provide an encoded media stream having different encoding parameters of the different genres, as determined by the ML model, in the manner of step 510 of FIG. 5.

In the following description, numerous specific details are set forth to provide a more thorough understanding of at least one embodiment. However, it will be apparent to one skilled in the art that the inventive concepts may be practiced without one or more of these specific details.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors.

In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. References may also be made to providing, outputting, transmitting, sending, or presenting analog or digital data. In at least one embodiment, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system comprising:
at least one execution unit to perform inference using a machine learning (ML) model to determine a genre associated with received frames of a media stream based at least in part on using ML model features associated with different genres; and
a video encoder to encode the media stream based at least in part on the determined genre.

2. The system of claim 1, wherein an encoded media stream output from the video encoder comprises at least two video sequences that are associated with different genres.

3. The system of claim 1, wherein an encoded media stream output from the video encoder comprises different video sequences that are associated with different encoding parameters representing different genres.

4. The system of claim 1, wherein the features comprise one or more of different noise features for the different genres, different distributions of motion vectors for the different genres, different intensity levels of pixels for the different genres, or different edge features for the different genres.

5. The system of claim 1, wherein the ML model is trained using supervised training, unsupervised training, or semi-supervised training.

6. The system of claim 1, further comprising a feedback loop from the video encoder to the at least one execution unit to indicate a scene cut event to the at least one execution unit, wherein an encoded media stream output from the video encoder comprises different encoding parameters that are provided dynamically for the encoded media stream based at least in part on the scene cut event.

7. The system of claim 1, further comprising a feedback loop from the video encoder to the at least one execution unit to indicate at least one of different encoding parameters used by the video encoder to the at least one execution unit, wherein the ML model is comprised of sub-ML models to perform different inferences for the received frames in response to the at least one of the different encoding parameters.

8. The system of claim 7, wherein the sub-ML models are of different associated memory or processing capacities, and wherein the at least one execution unit is to use one of the sub-ML models, in response to at least one of the different encoding parameters indicated to the ML model, based in part on a threshold capacity of at least one of the different associated memory or processing capacities.

9. The system of claim 1, wherein the inference using the ML model is performed on processed versions of one or more of the received frames.

10. The system of claim 1, wherein the inference using the ML model is performed using one or more sub-regions of one or more of the received frames.

11. The system of claim 1, wherein the ML model is controlled by an application to perform the inference based in part on an input from the application and wherein the video encoder is controlled by a processing infrastructure to perform the encoding of the media stream based in part on capabilities associated with the processing infrastructure.

12. The system of claim 11, wherein the application and the processing infrastructure share memory of the system to enable the inference and to enable the encoding of the media stream.

13. At least one execution unit to be associated with a video encoder, to perform an inference using a machine learning (ML) model to determine a genre associated with received frames of a media stream based in part on using ML model features associated with different genres, and to enable the video encoder to encode the media stream based in part on the determined genre.

14. The at least one execution unit of claim 13, wherein the features comprise one or more of different noise features for the different genres, different distributions of motion vectors for the different genres, different intensity levels of pixels for the different genres, and different edge features for the different genres.

15. The at least one execution unit of claim 13, wherein the ML model is trained using supervised training, unsupervised training, or semi-supervised training.

16. The at least one execution unit of claim 13, further comprising an input to receive feedback from the video encoder, the feedback to indicate a scene cut event to the at least one execution unit, wherein an encoded media stream output from the video encoder comprises different encoding parameters that are provided dynamically for the encoded media stream based at least in part on the scene cut event.

17. The at least one execution unit of claim 13, further comprising an input to receive feedback from the video encoder to indicate at least one of different encoding parameters used by the video encoder to the at least one execution unit, wherein the ML model is comprised of sub-ML models to perform different inferences for the received frames in response to the at least one of the different encoding parameters.

18. A video encoder to encode a media stream based at least in part on a genre associated with a media stream as inferred using a machine learning (ML) model performed on at least one execution unit, the genre determined from received frames of the media stream based at least in part on using ML model features associated with different genres.

19. The video encoder of claim 18, further comprising:
an output to provide feedback from the video encoder to the at least one execution unit, the output to indicate a scene cut event or at least one of different encoding parameters used by or available in the video encoder to the at least one execution unit, wherein the different encoding parameters are provided dynamically for the encoded media stream based at least in part on the scene cut event; and
an input to receive different inferences for the received frames in response to the at least one of the different encoding parameters, wherein the ML model is comprised of sub-ML models to provide the different inferences.

20. At least one execution unit to train a machine learning (ML) model using features associated with different genres for media streams, wherein the ML model, once trained, is to enable a video encoder to encode a media stream based in part on a genre inferred by the ML model for the media stream, and is to enable the video encoder to provide an encoded media stream based in part on the determined genre inferred by the ML model.

21. The at least one execution unit of claim 20, wherein the features comprise one or more of different noise features for the different genres, different distributions of motion vectors for the different genres, and different intensity levels of pixels for the different genres, or different edge features for the different genres.

22. A method for a video encoder, the method comprising:
performing a machine learning (ML) model to infer a genre associated with received frames of a media stream based at least in part on using ML model features associated with different genres; and
encoding the media stream using the video encoder based at least in part on the determined genre.

23. The method of claim 22, wherein the features comprise one or more of different noise features for the different genres, different distributions of motion vectors for the different genres, different intensity levels of pixels for the different genres, or different edge features for the different genres.

24. The method of claim 22, further comprising:
enabling a feedback loop from the video encoder to at least one execution unit performing the ML model; and
determining a scene cut event from feedback in the feedback loop, wherein the different encoding is provided dynamically for the media stream based at least in part on the scene cut event.

25. The method of claim 22, further comprising:
enabling a feedback loop from the video encoder to at least one execution unit performing the ML model;
determining at least one of different encoding parameters used by or available in the video encoder, and provided in the feedback loop to the at least one execution unit; and
using sub-ML models of the ML model to perform different inferences for the received frames in response to the at least one of the different encoding parameters.

26. The method of claim 22, wherein the sub-ML models are of different associated memory or processing capacities, and wherein the method further comprises:
determining a threshold capacity of at least one of the different associated memory or processing capacities; and
using one of the sub-ML models to perform the different inferences, in response to at least one of different encoding parameters from the video encoder and indicated to the ML model, based in part on the threshold capacity.
